(19) United States
(12) Patent Application Publication
(10) Pub. No.: US 2026/0009581 A1
(43) Pub. Date: Jan. 8, 2026

(54) APPARATUS AND METHODS FOR RAPID HEATING AND COOLING OF LIQUIDS

(71) Applicant: BOARD OF REGENTS, THE UNIVERSITY OF TEXAS SYSTEM, Austin, TX (US)

(72) Inventors: Marissa N. RYLANDER, Austin, TX (US); Christopher G. RYLANDER, Austin, TX (US)

(21) Appl. No.: 18/872,393

(22) PCT Filed: Jun. 5, 2023
(86) PCT No.: PCT/US2023/067916

§ 371 Date: Dec. 6, 2024

Related U.S. Application Data
(60) Provisional application No. 63/349,282, filed on Jun. 6, 2022.

(51) Int. Cl. F25D 31/00

(52) U.S. Cl. CPC F25D 31/005; F25D 31/002

(57) ABSTRACT

Apparatus and methods for cooling or heating a liquid in a container. In certain embodiments, the apparatus comprises a first conduit, a second conduit and a pump in fluid communication with the first conduit and the second conduit. The apparatus can also comprise a thermal energy transfer mechanism, where the pump is configured to transfer the liquid from the container to the thermal energy transfer mechanism via the first conduit, the thermal energy transfer mechanism is configured to cool or heat the liquid, and the pump is configured to transfer the liquid from the thermal energy transfer mechanism to the container via the second conduit.

### CROSS-REFERENCE TO RELATED APPLICATIONS

This application is a national phase application under 35 U.S.C. § 371 of International Application No. PCT/US2023/067916, filed Jun. 5, 2023, which claims the benefit of U.S. Provisional Patent Application No. 63/349,282 filed Jun. 6, 2022, the entirety of each of which is incorporated herein by reference.

### BACKGROUND INFORMATION

Existing products for heating or cooling liquids (e.g.; hot water bath, water/ice bath, wine refrigerator, etc.) typically rely on conduction of heat through an insulating vessel wall (glass or plastic material). Therefore, the time to reach desired liquid temperature can be unreasonably long creating end user frustration. Furthermore, the existing products often have no feedback or temperature controls to cease the heat transfer process when the liquid has reached the desired temperature. Over-or under-shooting the intended temperature can diminish the integrity, chemical composition, and health benefits (e.g., breast milk) and potentially the aromatic and gustatory properties of the liquid (e.g., wine). These existing devices often waste energy due to their lack of feedback and controls.

The U.S. Department of Human Services and numerous independent researchers document the tremendous health benefits of breast milk for babies [6-8]. Breast milk protects babies from infections and illnesses that include leukemia, diarrhea, ear infections, type 1 diabetes, ear infections, and pneumonia [6-8]. Breast milk also reduces the risk of sudden infant death syndrome (SIDS), bacterial meningitis, necrotizing enterocolitis, obesity, and respiratory infections like pneumonia, respiratory syncytial virus, and whooping cough [9,10]. Breast milk has significant economic benefits by saving families up to $1,500 in formula expenditures in the first year [11]. It is estimated that if 90% of U.S. families followed guidelines to provide breast milk exclusively for six months, the U.S. would annually save $13 billion from reduced medical and other costs [12]. Despite the significant health and economic benefits of breast milk, mothers and caregivers encounter significant challenges in the process of breastfeeding and providing milk via pumping, as well as inconvenience with storing and rewarming milk prior to feeding it to babies [13]. Following pumping, breast milk is typically stored in a refrigerator at 4° C. or in a freezer at −20° C. for preservation. Frequently, stored breast milk is rewarmed, ideally to 37°° C. to mimic body temperature of expressed milk [14]. Warm milk is more soothing, increasing the likelihood baby will accept the bottle, enables the fat layer to be dissolved into the milk so baby receives this important component, and requires less energy for the baby to digest since extra energy is needed to warm the milk in their stomach. For babies with low birth weight, feeding cold milk can lead to changes in body temperature that requires intervention or significant energy by the baby to return the body temperature back to normal [15,16]. Due to the enormous health benefits and significant time invested by mothers in providing milk, there is critical importance to preserving the valuable nutrients in milk which are highly sensitive to temperature elevations. Overheating milk can cause damage to the precious immune and stem cells and proteins, diminishing the health benefit for babies (see Task 2 for more details). A baby is conditioned to be fed on demand and expects the appropriate milk temperature of 37° C. as it exits the breast during nursing. Delays associated with warming pumped breast milk create emotional and physical distress that can lead to exacerbation of abdominal issues in babies suffering from colic by trapping more air in their stomach and increasing cortisol hormone secretion in the brain which can cause long-term damage to the brain itself, which reduces their capacity to learn [17]. Crying creates further danger for babies by causing stress for the caregiver in which accidents can happen including frustration induced injury to the child such as shaking baby syndrome [18].

Breast milk is a complex and dynamic fluid consisting of living somatic cells which include stem cells, leukocytes (1 million cells in a drop of breast milk), immune factors, and antibodies [37]. In addition, milk contains an optimal combination of nutrients and vitamins, water, lactose, protein, fat, and minerals in a form that can be more easily digested and processed by a baby than in formula [37]. Somatic cells in milk are responsible for release of enzymes including proteases and lipases which affect the characteristics of milk and immune functions. At threshold temperatures higher than 40° C., breast milk's nutritional and immunological value begins to deteriorate [16]. Traditional bottle warmers frequently exceed the 40° C. known to degrade the nutritional quality of breast milk [39]. Li et. al determined milk somatic cells maintained their viability between 39° C. (corresponding to temperature of healthy cows [40]) and 4° C. (temperature used for milk storage). In contrast, a significant decrease in cell viability to 3.0% and 0.7% was observed at 60° C. and 80° C., respectively, conditions that can be encountered during high temperature treatments such as pasteurization (63° C., 30 min) and ultra-high temperature (UHT), >140° C., 2-3 seconds, in dairy products [41]. During thermal treatments, changes in nutrients have been widely studied, such as alterations in proteins [42], lactose [43], and vitamins with minimal effect of heat on lactose and vitamins. The effects of thermal treatments on the stability of milk proteins mainly focus on the denaturation of whey proteins [45]. Whey proteins have received widespread attention based on their wide range of biological activities, including antibacterial activity and capability for fighting inflammatory disease, improving immunity, lowering blood pressure and cholesterol, and promoting bone repair [46]. Thermal treatments of milk induce changes in the properties of milk whey proteins, and thereby influence their function [47-51]. Zhang et. al. determined the nutrient differences in the whey proteins of dairy cow milk between pasteurization at 85° C. for 15 s or ultra-high temperature (UHT) at 135° C. for 15 s, thereby yielding data on the appropriate thermal treatments to use for raw milk [52].

Commercially available bottle warmers, consisting of an open bath and a submersed heater with a variable-power dial are often used to warm milk in the bottle. FIG. 1 illustrates a pictorial graph of lifecycle costs versus value (benefit) for different existing technologies to warm or cool liquids indicating a gap to be addressed by embodiments of the present disclosure, referred to herein as “RealCool”. Product (a) in FIG. 1 shows a popular bottle warmer with features representative of most warmers [18]. This technology is fairly inexpensive ($49 retail cost) but offers no feedback or control to shut off when the bottle is at the target temperature. Despite the reliance on traditional bottle warmers for rewarming milk, based on our 115 personal interviews with caregivers, it creates enormous emotional and physical distress for the baby and caregiver because they require too much time to warm milk to the desired body temperature. Bottle warmers rely on placing a plastic bottle containing milk into a hot water bath and transferring heat across the plastic to heat the milk. The thermally insulating plastic leads to poor heat conduction and extended time to warm the milk (8-30 minutes depending on power setting) (see FIG. 2). The inventors calculate this very inefficient heat transfer process results in a $21/year energy consumption based on the frequency of its intermittent use. Additionally, existing bottle warmers can create dangers for pediatric and caregiver burns [19]. There have been multiple reports of milk served at scalding temperatures burning the baby's mouth due to accidental overheating with bottle warmers [20]. Additionally, current designs have an open reservoir of hot water that can reach 50-100° C. which can accidentally spill on the baby and/or caregiver causing severe skin burns [20]. Hospital grade warmers incorporate some temperature feedback and safety features, but are still slow, and very expensive, and not available to purchase for home use, as shown in product (b) of FIG. 1 and in FIG. 2.

Similar to heating, liquids are typically chilled by means of conduction through an insulating vessel (often glass or plastic material), when it is not possible or desirable to add ice to the liquid. Enhancing the speed and precision of chilling has a wide range of applications in the medical and pharmaceutical arena for chilling vaccines, drugs, intravenous (IV) bags, and for beverages including iced coffee, sports drinks, wine, and spirits. Due to its inherent chemical complexity yet wide accessibility, wine will serve as our surrogate for a wide range of liquids for testing and de-risking related to the chilling capabilities of RealCooL technology. Wine has been imbibed since the beginning of human civilization for both enjoyment and for its perceived health benefits. Insufficient understanding and stigma permeate the fine line between the amount of alcohol that causes problems to organic systems and the amount that could be beneficial for health. Wine has a varying concentration of water, alcohol, and phenolic compounds, of which tannins, resveratrol, and quercetin have been the most studied. These polyphenols have positive effects on cardiac function and prevention of cardiovascular diseases by modulating cellular and molecular mechanisms that lead to anti-inflammatory, antioxidant, and hypotensive responses [22]. Some of these mechanisms have been well described and explored in therapeutic and preventive approaches for cardiovascular diseases [23]. The integrity and flavor of this complex fluid is highly sensitive to both temperature and oxidation state which will be regulated and affected by RealCooL, respectively. Changes in the chemical and sensory properties of a wine are a consequence of a range of complex chemical reactions. The effect of temperature on all of these chemical reactions can be understood and analyzed using established physical chemical principles captured with the Arrhenius equation [24]. As with milk warming, the Arrhenius equation forms the basis for the thermally induced cell injury associated with protein denaturation during milk warming.

The integrity and flavor of wine is highly sensitive to both temperature and oxidation state. Flavor and aroma are arguably the most important contributors to perceived wine quality. The aroma of wine is influenced by a range of volatile compounds (include ethyl esters, acetate esters, higher alcohols, fatty acids and aldehydes [61]) that originate from the grapes or as a result of the winemaking process, as well as ageing and storage. Sulfur dioxide (SO₂) is the most common additive used for wine preservation and inhibits the growth of microorganisms and protects wine against the effects of oxidative reactions [62]. Studies on the impact of temperature on wines tend to focus on the effect on antioxidants, such as sulfur dioxide (SO₂), color (especially browning of white wines) and volatile components (and their perception through sensory studies) [63]. While volatile compounds are important for aroma perception in wine matrices, non-volatile compounds play an important role in the palate characteristics of a wine and, in many cases, these can be equally sensitive to the impact of temperature. The chemistry changes involved in heat-affected red wines are generally more complex than they are in white wines, but it is arguable that white wines are more sensitive to the effect of heat and therefore require the same or a greater level of research consideration with respect to temperature effects. An unmet need is the collection of how a broad range of wine styles and range of temperatures affect comprehensive chemical and sensory analytical data to enable the impact of temperature to be modelled using known Arrhenius activation energies, this may allow estimation of the future condition of a wine with a known starting chemical composition, based on the time-temperature profile that it experiences. We will determine the impact RealCooL may have if any on the various forms of SO₂ and volatile activity, aroma, and taste.

One of the simplest technologies for wine chilling involves putting the wine bottle in a bucket of ice. This method is devoid of temperature control, relies on conduction with slow heat transfer (˜15 min to chill a bottle), but is inexpensive ($10 retail cost), as shown in product (c) of FIG. 1 and in FIG. 2. Wine refrigerators are the cooling-equivalent of hospital grade milk warmers in that they are a more sophisticated and expensive alternative for thermoregulation of fluids. Although wine refrigerators are typically equipped with a temperature control system maintaining the large volume at a specific temperature, there is not precise regulation or feedback when the actual wine within the bottle has reached the desired temperature. They also require significant time (approximately 2 hours to chill a standard 750 mL wine bottle from room temperature to 7° C.), Wine refrigerators run continuously and expend on average 58+ watts of power depending on size, resulting in an energy cost of $86/year based on a current rate of $0.17/kW-hr per day [25,26], as shown in product (d) of FIG. 1 and in FIG. 2.

Existing apparatus and methods for heating or cooling liquids are often unsatisfactory due to the extended timeframe needed for getting a liquid to the desired temperature. For example, existing technologies for warming beverages for babies including breast milk and formula focus on boiling water and causing a phase change in the surrounding liquid and transferring heat across the plastic bottle to heat the target volume. Therefore, the heat is being transferred across the insulating plastic leading to poor heat conduction and leading to extended time to warm the liquid. Furthermore, there is a need to quickly and efficiently reach the desired target temperature. Current technologies frequently overshoot the target temperature creating dangers for burns and requiring the user to cool the liquid back down frequently. This creates a vicious cycle of heating and cooling leading to frustration by the user and the target temperature is rarely met. Current products also lack feedback to the user and require constant, extended heating to get the liquid to the correct temperature and frequently the milk/formula gets too warm requiring the user to use more time to cool down.

In addition, existing systems and methods for cooling liquids also perform unsatisfactorily. For example, wine carafes can take an extended time to chill a bottle of wine because of the poor thermal conduction through the glass and poor aeration because they do not mix the wine within the bottle. As a second example, mixing cocktails with a traditional shaker has several disadvantages including manual labor required, extended time to cool the beverage, and dilution of ice into the beverage.

Accordingly, a need exists to provide for apparatus and methods for rapidly heating or cooling liquids to a desired temperature rapidly and precisely.

### SUMMARY

Embodiments of the present disclosure (also referred to herein as “RealCooL”) described herein were motivated by personal frustrations the inventors experienced with warming breast milk for their children, and were later validated as a common problem experienced by many caregivers (parents, daycare staff, hospital nursing staff). Two important beachhead markets were identified: breast milk warming and wine chilling, with the value propositions summarized in Table 1 below.

TABLE 1

| Warming milk | Chilling wine |
|---|---|
| Save time (20 times faster than baby bottle | Save time (120 times faster than wine |
| warmers): | refrigerators): |
| RealCooL can warm 240 mL milk from a | RealCooL can chill a 750 mL bottle of wine |
| refrigerated temperature (4° C.) to body | from room temperature (21° C.) to serving |
| temperature (37° C.) in just 24 seconds | temperature (7° C.) in 1 min whereas wine |
| compared to bottle warmer which takes 8 min | refrigerators require two hours |
| Preserves nutrients and cells because system | Higher-quality taste and better customer |
| heats to a precise temperature and heats | experience by providing wine at precise |
| uniformly | desired serving temperature |
| More energy efficient due to feedback-control | More energy efficient due to feedback-control |
| system and heating on demand | system and ice water on demand |

Exemplary embodiments of the present disclosure relate to apparatus and methods for apparatus and methods for rapid and precise heating or cooling of liquids. Particular embodiments relate to rapid heating or cooling of liquids including household beverages (e.g., breast milk, formula, sports drinks, alcoholic drinks, coffee, hot chocolate, apple cider, children's drinks) or pharmaceuticals or liquids used in medicine (e.g., blood, intravenous fluids, drugs, vaccines).

Exemplary embodiments can also relate to apparatus and methods for apparatus and methods for rapid and precise heating or cooling of solutions in the chemical industry where heating or cooling may affect reaction rates or creation of products or new solutions. Exemplary embodiments can also relate to pharmacologic applications for dissolving and resuspending powders in solution.

Exemplary embodiments of the present disclosure can quickly and precisely cool a glass or bottle of wine and provide aeration to improve taste and enjoyment. Exemplary embodiments can also allow mixed drinks to be prepared to a quickly and preferred chilled temperature and be mixed thoroughly without requiring addition of ice thereby preventing dilution.

In addition, exemplary embodiments of the present disclosure could couple with systems that intravenously deliver fluids (e.g. saline, drugs, blood) to provide solutions at body temperature to the patient. Exemplary embodiments may also provide heating or cooling of pharmaceuticals to maximize activity, efficacy, and distribution. Exemplary embodiments of the present disclosure may also be used to provide heating or cooling of liquids (e.g. water, drugs, chemicals, intravenous fluids) for military applications.

Exemplary embodiments may also be used to provide heating or cooling of liquids for livestock and pets particularly during extreme weather.

Exemplary embodiments include an apparatus for cooling or heating a liquid in a container, the apparatus comprising: a first conduit; a second conduit; a pump in fluid communication with the first conduit and the second conduit; a thermal energy transfer mechanism, where: the pump is configured to transfer the liquid from the container to the thermal energy transfer mechanism via the first conduit; the thermal energy transfer mechanism is configured to cool or heat the liquid; and the pump is configured to transfer the liquid from the thermal energy transfer mechanism to the container via the second conduit.

In certain embodiments, the thermal energy transfer mechanism comprises: a heat exchanger in fluid communication with the first conduit and the second conduit; and a reservoir. In some embodiments, the heat exchanger is located in the reservoir, and in particular embodiments the heat exchanger is external to the reservoir. In specific embodiments, the pump in fluid communication with the first conduit and the second conduit is a first pump; the apparatus further comprises a second pump; and the second pump is configured to circulate a thermal energy transfer fluid through the heat exchanger. Certain embodiments further comprise a heater in fluid communication with the second pump and the heat exchanger. In particular embodiments, the thermal energy transfer fluid is contained in the reservoir; and the thermal energy transfer fluid is colder than the liquid in the container. In some embodiments, the heater is configured to heat the thermal energy transfer fluid to a temperature that is hotter than the liquid in the container. Specific embodiments further comprise a plurality of control valves configured to: control a first flow of the thermal energy transfer fluid from the reservoir, through the second pump and heat exchanger and back to the reservoir; and control a second flow of the thermal energy transfer fluid from the pump, through the heater and heat exchanger and back to the second pump. Certain embodiments further comprise: a first actuator configured to insert and retract the first conduit into the container; and a second actuator configured to insert and retract the second conduit into the container.

In particular embodiments, the reservoir comprises an inlet and an outlet. In some embodiments, the inlet is in fluid communication with a fluid source, and in specific embodiments the fluid source comprises a hot fluid source or a cold fluid source.

Certain embodiments further comprise a temperature sensor configured to monitor the temperature of the fluid in the first conduit or the temperature of the fluid in the container. Particular embodiments further comprise a control valve configured to control a flow of fluid from the fluid source. In some embodiments, the control valve is a water faucet in a residential or commercial sink. Specific embodiments further comprise one or more heat transfer elements in a fluid in the reservoir. In certain embodiments, the one or more heat transfer elements comprise ice. In particular embodiments, the one or more heat transfer elements comprise a heating element. Some embodiments further comprise a stirring mechanism. In certain embodiments, the stirring mechanism is configured to stir the heat transfer elements and the fluid within the reservoir.

Particular embodiments further comprise a temperature sensor configure to monitor the temperature of the fluid in the second conduit. Some embodiments further comprise a temperature sensor configured to monitor the temperature of the fluid in the reservoir. In specific embodiments, the reservoir comprises an outlet coupled to a drain. Certain embodiments further comprise a container comprising a cleaning fluid. In particular embodiments, the apparatus is configured to circulate the cleaning fluid through the first conduit, the second conduit, the pump and the thermal energy transfer mechanism. In particular embodiments, cleaning fluid could be water of any temperature and also be elevated to comply with NSF/ANSI 3 standards for domestic products in the kitchen including glassware, bottles, pumping accessories are sanitized with a dishwasher or hand washing. NSF/ANSI 3 establishes design, construction, material and performance requirements for commercial dishwashers used in restaurants and other facilities subject to public health inspections, while NSF/ANSI 184 sets requirements for residential dishwashers. For example, the requirements for both residential and commercial dishwashers are meant to achieve a minimum 99.999 percent or 5-log reduction of bacteria. For commercial dishwashers this condition can be met by reaching a final rinse temperature of 74° C. for stationary rack dishwashers and 82° C. for all other commercial style dishwashers (NSF/ANSI 3) and for residential dishwashers must reach a final rinse temperature of 66° C. (NSF/ANSI 184) [34]. Some embodiments further comprise a controller configured to control operation of the apparatus. In specific embodiments, the controller comprises an on/off selector, a temperature set point controller, and a temperature set point display. In certain embodiments, the controller comprises a clean cycle selector.

Particular embodiments include a method for cooling or heating a liquid in a container, the method comprising: obtaining an apparatus according to any one of claims as described herein; transferring the liquid from the container to the thermal energy transfer mechanism via the first conduit; and transferring the liquid from the thermal energy transfer mechanism to the container via the second conduit.

In the present disclosure, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The terms “approximately, “about” or “substantially” mean, in general, the stated value plus or minus 10%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

As used herein the terms “first conduit” and “second conduit” includes both conduits that are separate from each other, as well as first and second portions of a continuous conduit. For example, a single conduit coupled to a peristaltic pump coupled can comprise a “first conduit” at inlet side of the pump and a “second conduit” at the outlet side of the pump.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee

The following drawings form part of the present specification and are included to further demonstrate certain aspects of the present invention. The invention may be better understood by reference to one or more of these drawings in combination with the detailed description of specific embodiments presented herein.

FIG. 1 illustrates a pictorial graph of lifecycle costs versus value for different technologies used for heating or cooling liquids.

FIG. 2 illustrates a table comparing features of different technologies used for heating or cooling liquids.

FIG. 3 illustrates a schematic view of an apparatus according to an exemplary embodiment of the present disclosure.

FIG. 4 illustrates a graph of transient temperature of target fluid versus time according to a simulation of an exemplary embodiment of the present disclosure.

FIG. 5 illustrates a table showing fluid temperatures versus time for an apparatus according to an exemplary embodiment of the present disclosure in heating mode.

FIG. 6 illustrates a table showing fluid temperatures versus time for an apparatus according to an exemplary embodiment of the present disclosure in cooling mode.

FIG. 7 illustrates a schematic view of an apparatus according to an exemplary embodiment of the present disclosure.

FIG. 8 illustrates a graphical user interface according to an exemplary embodiment of the present disclosure.

FIG. 9 illustrates a schematic view of an apparatus according to an exemplary embodiment of the present disclosure.

FIG. 10 illustrates a graphical user interface according to an exemplary embodiment of the present disclosure.

FIG. 11 illustrates a graph of fluid temperature versus time for raw cow milk heated by an apparatus according to an exemplary embodiment of the present disclosure.

FIG. 12 illustrates a graph of fluid temperature versus time for wine cooled by an apparatus according to an exemplary embodiment of the present disclosure.

FIG. 13 illustrates a photographic comparison of Agar Plate results for bacterial colonization quantification for different sanitation techniques used with an exemplary embodiment of the present disclosure.

FIG. 14 illustrates a graph displaying the results of the cell viability using different warming methods for milk.

### DETAILED DESCRIPTION OF ILLUSTRATIVE EMBODIMENTS

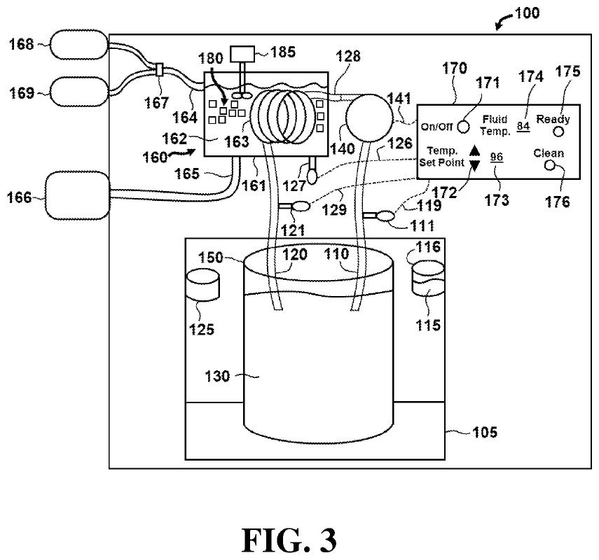

Referring now to FIG. 3, an apparatus 100 is shown for cooling or heating a liquid 130 in a container 150. In the embodiment shown, apparatus 100 comprises a first conduit 110 and a second conduit 120, as well as a pump 140 in fluid communication with first conduit 110 and second conduit 120. In the illustrated embodiment, apparatus 100 also comprises a thermal energy transfer mechanism 160, where pump 140 is configured to transfer liquid 130 from container 150 to thermal energy transfer mechanism 160 via first conduit 110. Certain embodiments may also incorporate a conduit 128 between pump 140 and thermal transfer energy mechanism 160. Pump 140 is also configured to transfer liquid from thermal energy transfer mechanism 160 back to container 150 via second conduit 120. In particular embodiments, pump 140 is a self-priming pump (e.g. a diaphragm pump) and pump 140 can continually circulate liquid 130 from container 150 to thermal energy transfer mechanism 160 and back to container 150. In the embodiment shown, thermal energy transfer mechanism 160 is configured to cool or heat liquid 130 to a specified temperature selected by a user.

In one exemplary embodiment, a user may place container 150 in a receptacle 105 of apparatus 100 and insert first conduit 110 and second conduit 120 into container 150. In particular embodiments, first conduit 110 and second conduit 120 may be joined or coupled together via clip, band, tie, etc. to allow a user to insert first conduit 110 and second conduit 120 simultaneously into container 150. Apparatus 100 may also comprise flexible supports for first conduit 110 and second conduit 120 configured to allow a user to manipulate first conduit 110 and second conduit 120 for easy insertion into container 150. The user may then begin the process of heating or cooling of liquid 130, e.g. by initiating operation of apparatus 100 via a controller 170. In particular embodiments controller 170 may comprise an “On/Off” selector 171 (e.g. a button or switch), as well as a temperature set point controller 172, a temperature set point display 173 and a fluid temperature display 174. In certain embodiments, apparatus 100 may be electrically coupled to a standard electrical outlet (e.g. 110 volt, not shown) so that electrical power is suppled to components of apparatus 100 when the “On/Off” selector is placed in the “On” position and the actual fluid temperature is not at the set point temperature. After turning on apparatus 100, the user can adjust temperature set point controller 172 until temperature set point display 173 displays the selected temperature set point.

In the embodiment shown, pump 140 transfers liquid 130 from container 150 to thermal energy transfer mechanism 160 via first conduit 110. In specific embodiments, apparatus 100 comprises a temperature sensor 111 configured to monitor the temperature of fluid 130 prior to liquid 130 reaching thermal energy transfer mechanism 160. In the embodiment shown, temperature sensor 111 configured to monitor the temperature of liquid 130 in first conduit 110 as liquid 130 is being transferred from container 150 to thermal energy transfer mechanism 160. In particular embodiments, temperature sensor 111 is proximal to container 150, and in certain embodiments, temperature sensor 111 can be configured to monitor the temperature of liquid 130 in container 150.

In particular embodiments, temperature sensor 111 can transmit a feedback signal 119 to controller 170, where feedback signal 119 indicates the temperature of liquid 130 in first conduit 110. If feedback signal 119 indicates the temperature of liquid 130 in first conduit 110 is less than the temperature set point, apparatus 100 can heat liquid 130 via thermal energy transfer mechanism 160. Conversely, if control signal 119 indicates the temperature of liquid 130 in first conduit 110 is greater than the temperature set point, apparatus 100 can cool liquid 130 via thermal energy transfer mechanism 160. Particular embodiments may also comprise a temperature sensor 121 that can transmit a feedback signal 129 to controller 170 that indicates the temperature of liquid 130 in second conduit 120. Certain embodiments may also comprise a temperature sensor 127 that can transmit a feedback signal 126 to controller 170 that indicates the temperature of thermal energy transfer fluid 162. By comparing the temperature transmitted from temperature sensor 111 to the temperature transmitted from temperature sensor 127, controller 170 can determine if the temperature set point display 173 is achievable or if the temperature set point display 173 is out of range. If the temperature set point display 173 is out of range (e.g. higher than the temperature transmitted from temperature sensor 127 when apparatus 100 is in heating mode, or lower than the temperature transmitted from temperature sensor 127 when apparatus is in cooling mode), controller 170 can alert the user and/or turn off components, including for example, pump 140.

In the example shown in FIG. 3, the user has selected a temperature set point of 96 degrees Fahrenheit and temperature sensor 111 indicates a temperature of 84 degrees Fahrenheit for liquid 130 in first conduit 110. Accordingly, controller 170 can initiate operation of pump 140 via a control signal 141 so that liquid 130 is transferred from container 150 to thermal energy transfer mechanism 160 to heat liquid 130. In the particular embodiments shown, thermal energy transfer mechanism 160 comprises a heat exchanger 163 in fluid communication with first conduit 110 and second conduit 120. In specific embodiments heat exchanger 163 may be configured as one or more coils, while in other embodiments, heat exchanger 163 may comprise a plurality of plates, fins, tubes or other components configured to transfer thermal energy from an external environment to liquid 130 contained within heat exchanger 163. In certain embodiments, first conduit 110, second conduit 120 and heat exchanger 163 may be formed from a single component (e.g. a single piece of continuous flexible tubing), while in other embodiments, first conduit 110, second conduit 120 and heat exchanger 163 may be formed from separate components.

In the specific embodiment shown in FIG. 3, thermal energy transfer mechanism 160 comprises a reservoir 161 with a thermal energy transfer fluid 162 to transfer thermal energy to the external surface of heat exchanger 163. In particular embodiments, reservoir 161 may be insulated to reduce the transfer of thermal energy between the contents of reservoir 161 and the outside environment. In specific embodiments, reservoir 161 may comprise an inlet 164 and an outlet 165 that can be used to drain thermal energy transfer fluid 162 from reservoir 161. In particular embodiments, inlet 164 may be in fluid communication with a hot fluid source 168 and a cold fluid source 169 configured to provide thermal energy transfer fluid 162 to reservoir 161 of thermal energy transfer mechanism 160. In certain embodiments, a control valve 167 (or multiple control valves) can be configured to selectively allow fluid flow from either hot fluid source 168 or cold fluid source 169 to reservoir 161 via inlet 164. In particular embodiments, control valve 167 may be manually controlled by a user, or may be automatically controlled by apparatus 100. In certain embodiments, hot fluid source 168 and cold fluid source 169 may be hot and cold water supplies, including for example, those available in residential homes or commercial buildings. In certain embodiments, control valve 167 may be a water faucet in a residential or commercial sink. While the embodiment illustrates inlet 164 in fluid communication with both a hot fluid source and a cold fluid source, it is understood that other embodiments may comprise an inlet in fluid communication with either a hot fluid source or a cold fluid source.

Outlet 165 may also be coupled to a drain reservoir 166 configured to receive thermal energy transfer fluid 162 from reservoir 161 of thermal energy transfer mechanism 160. In particular embodiments, drain reservoir 166 may be a sink or other suitable basin coupled to a plumbing system in a residential or commercial building.

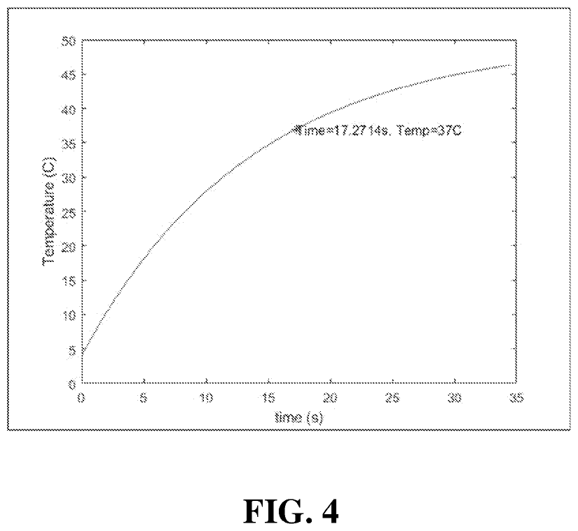

In specific embodiments, apparatus 100 is capable of rapidly increasing or decreasing the temperature of liquid 130 by providing a flow of thermal energy transfer fluid 162 to thermal energy transfer mechanism 160. Providing a flow of thermal energy transfer fluid 162 into and out of reservoir 161 allows for a more rapid temperature change to liquid 130 in comparison to certain systems utilizing a heat exchanger with a fixed volume of thermal energy transfer fluid. A computational algorithm is included at the conclusion of this section demonstrating potential thermal energy transfer capabilities of an exemplary embodiment. In the simulation, the inputs to the code include design geometries of the conduit (e.g. pipe) and volume of fluid to be heated/cooled, as well as material and thermal properties of fluid to heat/cool, the water from the faucet, and the pipe (e.g., copper). The equations for heat transfer programmed within the code then calculate: (1) the internal thermal/fluid parameters of the target fluid; (2) external thermal/fluid parameters of the water from the hot fluid source (e.g. faucet); (3) overall heat transfer coefficient of the system; and (4) transient temperature of the target fluid based on lumped capacitance method. FIG. 4 illustrates the transient temperature of target fluid versus time and marks the time when the temperature reaches the target value (37 C) based on theoretical model predicted temperature using heat transfer analysis.

In some existing systems with a fixed volume of thermal energy transfer fluid, the temperature of the thermal energy transfer fluid rapidly approaches the temperature of the subject liquid (e.g., liquid 130) due to the limited volume of thermal energy transfer fluid and the transfer of thermal energy between the two fluids. For example, in fixed volume thermal energy transfer fluid systems configured to heat the subject fluid, the temperature of the thermal energy transfer fluid is continually decreased by the subject fluid until the two fluid temperatures approach equivalency.

Similarly, in certain existing fixed volume thermal energy transfer fluid systems configured to cool the subject fluid, the temperature of the thermal energy transfer fluid is continually increased by the subject fluid until the two fluid temperatures approach equivalency. As the temperature of the thermal energy transfer fluid approaches the temperature of the subject fluid, less thermal energy is transferred between the two fluids—resulting in less efficient thermal energy transfer with the subject fluid. This can require significantly longer times and/or large volumes of thermal energy transfer fluid to achieve the desired temperature in the subject fluid. A fixed volume of thermal energy transfer fluid can also limit the volume of the subject fluid that can be heated or cooled, as well as the maximum or minimum temperature to which the subject fluid can be heated or cooled.

In contrast to fixed volume systems, the embodiment shown in FIG. 3 can provide a continuous flow of thermal energy transfer fluid 162, which provides a constant temperature of thermal energy transfer fluid 162 to heat exchanger 163. This can maintain a greater difference in the temperature between thermal energy transfer fluid 162 and liquid 130, allowing for more effective heat transfer between the fluids and resulting in reduced time for liquid 130 to reach the temperature set point. In particular embodiments heat exchanger 163 is completely submerged in thermal energy transfer fluid 162 to provide efficient transfer of thermal energy between fluid 162 and fluid 130 contained within heat exchanger 163.

In certain embodiments, apparatus 100 may also comprise a stirring mechanism 185 configured to stir the contents of reservoir 161. In particular embodiments, stirring mechanism 185 may comprise a rotating shaft with paddles or other suitable elements configured to stir or mix the contents of reservoir 161. In certain embodiments, stirring mechanism 185 may be configured as a pump configured to circulate liquid 162 within reservoir 161. In certain embodiments a user may add one or more thermal energy transfer elements 180 to reservoir 161. In specific embodiments, thermal energy transfer elements 180 may comprise a heating element (e.g. submersible electrical resistance heater), which can be submerged below liquid 162 to further facilitate heating provided to heat transfer mechanism 163. In particular embodiments, the submersible electrical resistance heater may be continuously operated to heat thermal energy transfer fluid 162 so that apparatus 100 can be quickly implemented to raise the temperature of liquid 130 without having to wait for the temperature of thermal energy transfer fluid 162 to be increased before use.

In specific embodiments, thermal energy transfer elements 180 may comprise ice (e.g., ice cubes), which can be added to liquid 162 to further facilitate cooling provided to heat transfer mechanism 163. In specific embodiments, ice cubes can be added to reservoir 161 and cold fluid (e.g., from cold fluid source 169 and/or from an external source that may provide colder fluid than cold fluid source 169) can be added to cover the ice cubes and fill in the gaps between the ice cubes. Stirring mechanism 185 could then be operated to stir or circulate the contents of reservoir 161 (e.g., fluid 162 and heat transfer elements 180). In certain embodiments, heat transfer elements could be similarly used to increase the temperature of contents of 161 in conjunction with fluid from hot fluid source 168 and/or an external source of hot fluid. Accordingly, heat transfer elements 180 and stirring mechanism 185 can provide rapid cooling or heating to heat transfer mechanism 163. It is understood that while the embodiment shown in FIG. 3 includes provisions for continuous flow of thermal energy transfer fluid 162 (e.g., hot fluid source 168, cold fluid source 169, control valve 167 and outlet 165) as well as thermal energy transfer elements 180 and stirring mechanism 185, exemplary embodiments of the present disclosure may not include all of the elements shown in FIG. 3. For example, certain embodiments may include thermal energy transfer elements 180 and stirring mechanism 185 but not include provisions for continuous flow of thermal energy fluid 162. Other exemplary embodiments may include provisions for continuous flow of thermal energy fluid 162 but may not include thermal energy transfer elements 180 and stirring mechanism 185.

After liquid 130 has reached the desired temperature set point, apparatus 100 can notify a user via a visual and/or an audible alert 175. Apparatus 100 may also turn off pump 140 and/or thermal energy transfer elements 180 and/or stirring mechanism 185 when liquid 130 has reached the desired temperature set point. The user may then remove first conduit 110 and second conduit 120 from container 150 and remove container 150 from apparatus 100 so that liquid 130 can be used as desired. In particular embodiments pump 140 can be operated for a period of time after first conduit 110 and second conduit 120 are removed from container 150 to transfer residual liquid back to container 150.

The user may then also initiate a cleaning cycle for apparatus 100 if desired. In a particular embodiment, the user can initiate the cleaning cycle by placing first conduit 110 in a container 116 of cleaning fluid 115, second conduit 120 in cleaning fluid drain 125, and manipulating a clean cycle selector 176, e.g., by pushing a button or toggling a switch.

In particular embodiments, cleaning fluid 115 may comprise water, soap, alcohol, or other suitable cleaning agents. In certain embodiments cleaning fluid 115 may comprise fluid from hot fluid source 168, including for example, hot water from a water faucet or tap. In certain embodiments, cleaning fluid drain 125 may be in fluid communication with drain reservoir 166. During the cleaning cycle, apparatus 100 can activate pump 140 to circulate cleaning fluid 115 through first conduit 110, heat exchanger 163 and second conduit 120 and into cleaning fluid drain 125. This can remove liquid 130 and clean first conduit 110, heat exchanger 163 and second conduit 120. In certain embodiments, activating clean cycle selector 176 can initiate a cleaning cycle for a specific period of time (e.g., 5, 10, 15 or 30 seconds, 1 minute, 2 minutes, 3 minutes, 4 minutes, 5 minutes or more) of sufficient duration to ensure liquid 130 is evacuated from first conduit 110, heat exchanger 163 and second conduit 120 and the components of apparatus 100 are clean. Apparatus 100 is then ready for a user to begin the next heating or cooling cycle for a fluid in a container.

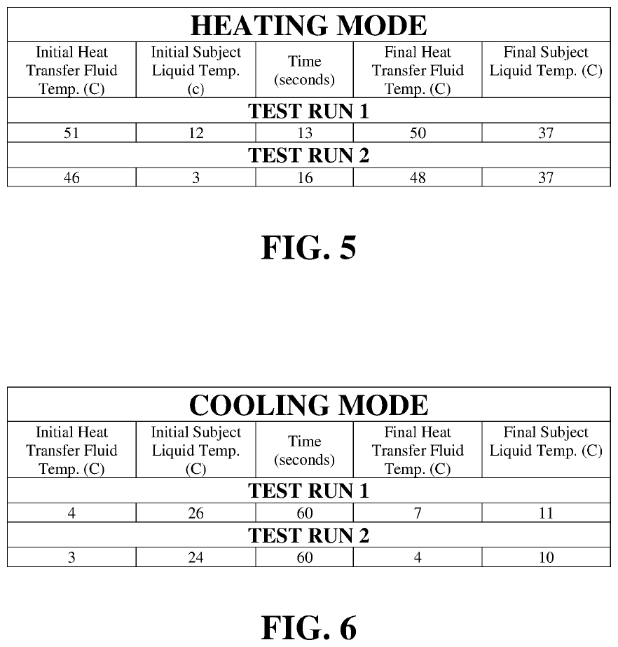

FIG. 5 illustrates a table showing measured fluid temperatures versus time for an apparatus according to an exemplary embodiment of the present disclosure in heating mode. In this example, the subject fluid was 8 fluid ounces of water (simulating an infant bottle of milk), and an electrical resistance heater was used to heat the heat transfer fluid. As shown in the table, the subject fluid temperature was raised from 12 degrees Celsius to 37 degrees Celsius in only 13 seconds in the first test run. In the second test run, the subject fluid temperature was raised from 3 degrees Celsius to 37 degrees Celsius in only 16 seconds.

FIG. 6 illustrates a table showing measured fluid temperatures versus time for an apparatus according to an exemplary embodiment of the present disclosure in cooling mode. In this example, the subject fluid was 750 milliliters of water (simulating a bottle of wine), and ice was added to cool the heat transfer fluid. As shown in the table, the subject fluid temperature was decreased from 26 degrees Celsius to 11 degrees Celsius in only 60 seconds in the first test run. In the second test run, the subject fluid temperature was decreased from 24 degrees Celsius to 10 degrees Celsius in only 16 seconds.

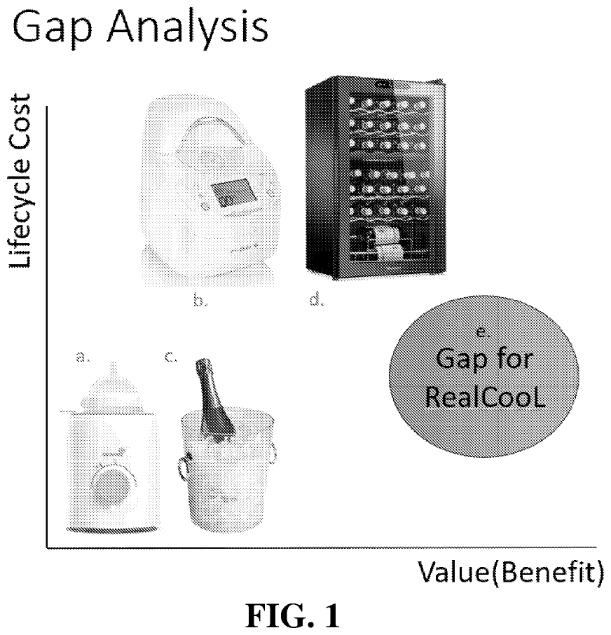

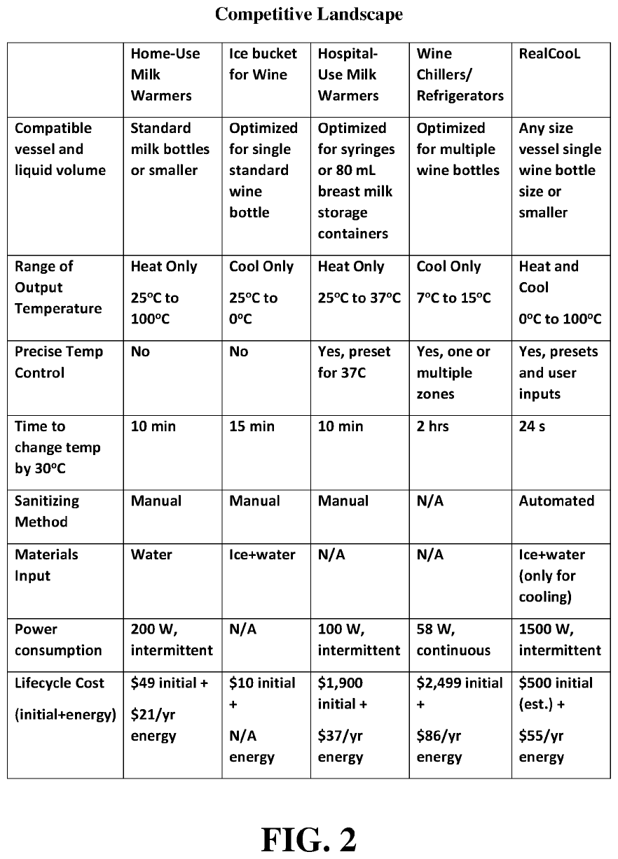

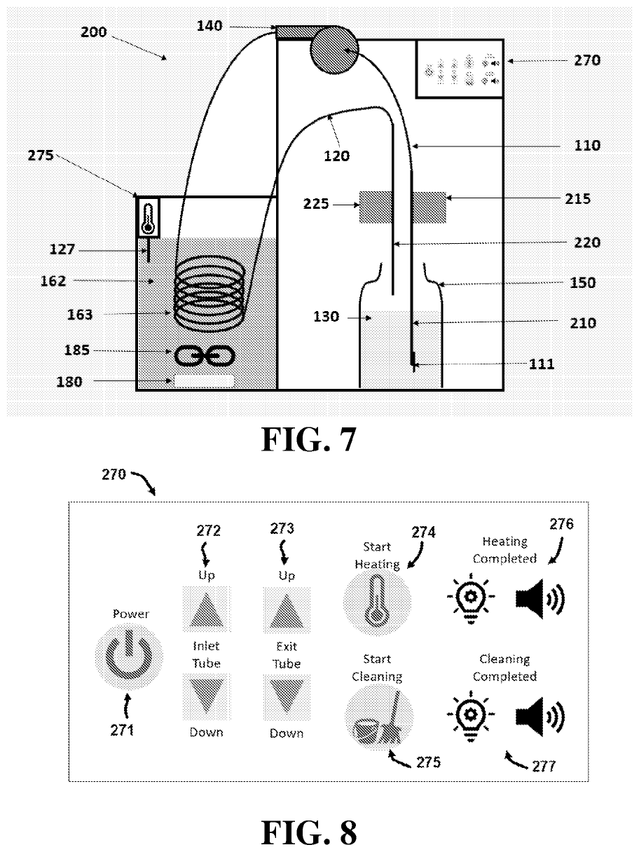

Referring now to FIG. 7, an embodiment of an apparatus 200 for heating liquid is shown that is similar to the previously described embodiment, but also includes additional features. Elements of apparatus 200 that are equivalent to the previously described embodiment are denoted with identical reference numbers to apparatus 100 shown in FIG. 1. For sake of clarity, the aspects of apparatus 200 that are equivalent to those of apparatus 100 will not be described in the discussion of FIG. 7, but the equivalent elements are understood to function and operate in the manner described above in the discussion of apparatus 100.

In addition to the equivalent elements of apparatus 100, apparatus 200 comprises actuators 215 and 225 configured to raise and lower an inlet conduit 210 and an exit conduit 220. In particular embodiments, inlet conduit 210 and exit conduit 220 may be rigid conduits (including for example, stainless steel tubing) couple to first conduit 110 and second conduit 120, respectively. In certain embodiments, actuators 215 and 225 can be configured as linear actuators comprising electric motors that can raise and lower inlet conduit 210 and exit conduit 220 so that inlet conduit 210 and exit conduit 220 are submerged or not submerged in liquid 130 contained in container 150. In the illustrated embodiment, apparatus 200 comprises a control panel 270 (also shown in FIG. 8 in an enlarged view) configured to control operation of apparatus 200, including actuators 215 and 225.

As shown in FIG. 8, control panel 270 comprises a power (e.g., on/off) selector 271, an inlet tube controller 272 (configured to raise and lower inlet conduit 210), and an exit tube controller 273 (configured to raised and lower exit conduit 220). In addition, control panel 270 comprises a heating mode controller 274 and a cleaning mode controller 275, as well as a heating completed indicator 276 and a cleaning completed indicator 277.

For heating, a user can place container 150 containing liquid 130 beneath inlet conduit 210 and exit conduit 220. The user can then engage inlet tube controller 272 by pressing the “Down” indicator to lower inlet conduit 210 into liquid 130. In certain embodiments, an electrical circuit for control panel 270 is housed in the base of apparatus 200 and actuates the inlet and exit conduits 210 and 220 through a motor driver for a stepper motor for each conduit. In specific embodiments, the stepper motors provide automated motion of the inlet and exit tubes at a speed of 1 in/s of travel. Each button triggers either clockwise or counterclockwise motion of the stepper motor, which translates via a leadscrew to the linear motion of the tubes. In order to prevent damage to apparatus 200, the allowed range of motion of inlet conduit 210 and exit conduit 220 can be limited via a limit switch or other appropriate device. Once inlet conduit 210 and exit conduit 220 are positioned, the user can press heating mode controller 274 button and pump 140 circulates fluid 130 from inlet conduit 210 through heat exchanger 163 (e.g., a stainless-steel coil in certain embodiments) immersed thermal energy transfer fluid 162 and back to container 130 via exit conduit 220. Heat is transferred between thermal energy transfer fluid 162 and fluid 130 via heat exchanger 163.

In certain embodiments temperature sensor 111 may be configured as a T-type thermocouple coupled to inlet conduit 210 that allows continuous monitoring of the fluid 130 temperature. The heating cycle runs until the desired target temperature of fluid 130 is reached (e.g., apparatus 200 can be internally programmed to heat milk to 37 degrees Celsius). Apparatus 200 can provide a visual and/or auditory signal to the user when the heating cycle is complete heating completed indicator 276. Apparatus 200 can then automatically retract inlet conduit 210 and exit conduit 220 from container 130 and stop operation of pump 140 so that the user can remove the container 130.

In certain embodiments for cleaning mode, the user can place a container of hot tap water beneath inlet conduit 210, and an empty container of equal or greater size beneath the exit conduit 220. Similar to the heating mode, the user adjusts the inlet and exit tube positions via the inlet tube controller 272 and exit tube controller 273 on control panel 270 such that inlet tube 210 is inserted near the bottom of the water container and he exit tube 220 is placed above the empty container. The user can then press cleaning mode controller 275, which automatically runs pump 140 for an appropriate length of time (e.g., 1 minute in certain embodiments, during which time the user can step away).

During cleaning mode, apparatus 200 can pump the hot clean water in a single-pass through inlet conduit 210, first conduit 110, pump 140, second conduit 120, heat exchanger 163, second conduit 120 and exit conduit 220, discharging all the contents via exit tube 220 into the waste container. When the cleaning cycle is complete, inlet conduit 210 and exit conduit 220 can be automatically withdrawn, and the user is notified by visual and/or auditory indicators via cleaning completed indicator 277 that they can remove the two containers from the system. Apparatus 200 is now ready to be used for the next heating cycle.

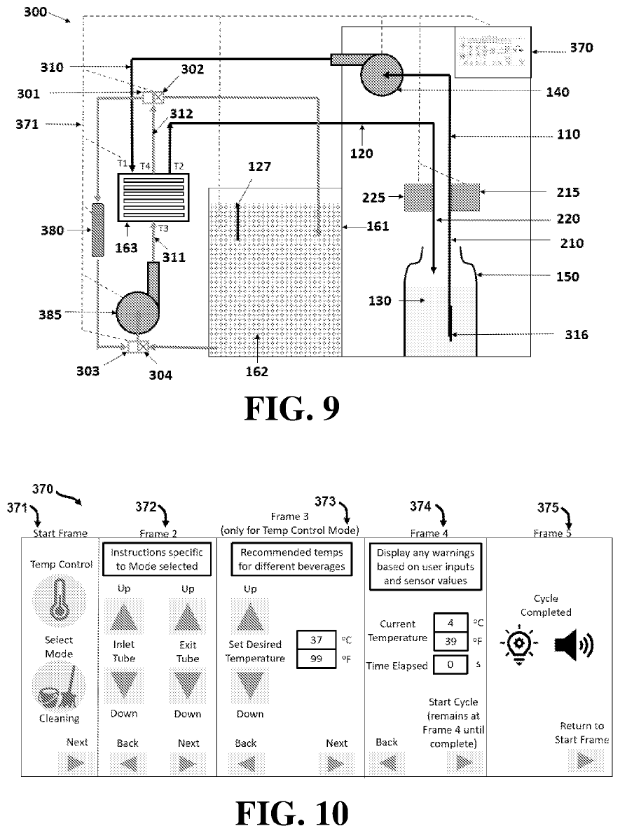

Referring now to FIG. 9, an embodiment of an apparatus 300 for heating and cooling liquid is shown that is similar to the previously described embodiments, but also comprises a heat exchanger 163 that is external to reservoir 161. Elements of apparatus 300 that are equivalent to the previously described embodiments are denoted with identical reference numbers to apparatus 100 shown in FIG. 3 and apparatus 200 shown in FIG. 7. For sake of clarity, the aspects of apparatus 300 that are equivalent to those of apparatus 100 and 200 will not be described in the discussion of FIG. 9, but the equivalent elements are understood to function and operate in the manner described above in the discussion of apparatus 100 and 200.

Apparatus 300 also comprises an inline heater 380 configured to heat thermal energy transfer fluid during heating or sanitization procedures. In certain embodiments, heat exchanger 163 may be configured as a plate heat exchanger with inlets and outlets for liquid 130 and for thermal energy transfer fluid 162. In particular embodiments, heat exchanger 163 may be a stainless-steel brazed plate, food-safe Model B3-5A 10 Plate by Duda Energy™ capable of 1.5 kW heat transfer and approximately 2 inches by 5 inches by 2 inches in size.

In the embodiment shown in FIG. 9, heat exchanger 163 is placed outside of reservoir 161, which can contain an ice water bath as thermal energy transfer fluid 162 for use during cooling procedures. This configuration allows apparatus 300 to switch rapidly between heating or cooling modes of operation. Rapid switching between heating and cooling modes is further enabled with the addition of four normally-off solenoid valves 301, 302, 303 and 304 at inlets and outlets of heat exchanger 163 for thermal energy transfer fluid 162.

In the heating or sanitization mode, valves 301 and 303 are open and valves 302 and 304 are closed as shown in FIG. 9. For the cooling-mode configuration (not shown), valves 301 and 303 switch to the closed position, and valves 302 and 304 switch to the open position. If apparatus 300 is not actively heating or cooling a liquid or sanitizing, then all valves 301-304 can return to their normally-closed state, requiring zero energy consumption. In certain embodiments, the location of heat exchanger 163 outside of reservoir 161 can provide for an overall energy efficiency improvement for heating on demand rather than continuously heating the contents of reservoir 161.

In addition, the location of heat exchanger external to reservoir 161 allows a user to rapidly increase temperature intermittently to 65 degrees C. or 82 degrees C. to be compliant with NSF/ANSI sanitization standards. A water reservoir system has intrinsic thermal capacitance which makes a temperature response much slower. In specific embodiments, inline heater 380 will only be powered on intermittently during heating mode while solenoid valves 301 and 303 are open and pump 385 is running in order to control temperature entering heat exchanger 163.

In particular embodiments pump 385 is a food-grade diaphragm pump. The placement of pump 385 between solenoid valves 303 and 304 and heat exchanger 163 water inlet allows circulation of either hot water or cold water with just a single pump. In certain embodiments, pump 385 and pump 140, will be identical to reduce costs associated with manufacturing and maintenance. In particular embodiments, both pumps 140 and 385 have an operating water temperature range from 0-70 degrees, C., a pressure range up to 0.5 MPa, and a flowrate up to 6 L/min.

With the added ability of the new heat exchanger, inline heater, and solenoid valves to switch rapidly between heating and cooling modes, control system 371 has been configured accordingly. Temperature sensors (e.g., K-type thermocouples) are located at each inlet and outlet of heat exchanger 163. Specifically, T1 measures the temperature of fluid 130 at a first inlet of heat exchanger 163, which is coupled to pump 140 via conduit 310. In addition, T2 measures the temperature of fluid 130 at a first outlet of heat exchanger 163 which is in fluid communication with container 150 via conduit 120. T3 measures the temperature of thermal energy transfer fluid 162 at a second inlet of heat exchanger 163 which is coupled to pump 385 via conduit 311, and T4 measures the temperature of thermal energy transfer fluid 162 at a second outlet of heat exchanger 163 which is in fluid communication with valves 301 and 302 via conduit 312. In addition, temperature sensor 127 is located within container 161 to measure the temperature of thermal energy transfer fluid 162 in container 161 and temperature sensor 316 is coupled to inlet conduit 210 to measure the temperature of liquid 130 when inlet conduit is lowered into container 130. Temperature sensors 127 and 316 may also be configured as K-type thermocouples.

In certain embodiments control system 371 comprises a microprocessor configured to use the temperature inputs from each of the temperature sensors T1-T4, 127 and 316 and known thermodynamic and heat transfer relationship to control solenoid valves 301-304, pumps 140 and 385, heater 380, and actuators 215 and 225. It is understood that the arrows shown in FIG. 10 indicating the direction of fluid flow are merely indicative of one exemplary embodiment. For example, the direction of fluid flow with respect to pump 385 could be reversible, e.g., if pump 385 is configured as a self-priming pump. Reversal of flow through pump 385 could be desired dependent on whether apparatus 300 was in a heating or cooling mode of operation. For example, by reversing the flow through heater 380 from that shown in FIG. 10, increased efficiency of thermal energy transfer to liquid 130 may be obtained through heat exchanger 163 because the thermal energy transfer fluid would not have to pass through pump 385 before entering heat exchanger 163.

In particular embodiments, container 161 may be configured as a two-liter, double wall vacuum-insulated cooler, including for example, those available from Yeti®. Such a configuration can reduce costs associated with manufacturing, assembly, and servicing of apparatus 300 because container 161 has fewer total parts, no moving parts, and it does not consume any electricity to produce ice. Many residential customers already have access to a sufficient volume of ice needed to chill a bottle of wine using apparatus 300 available from their residential freezers. This ice can be produced efficiently in their freezer, and can easily be transferred into container 161 when a cooling cycle is desired.

In particular embodiments, the user will not need to specify heating or cooling mode as an input to control system 371 prior to operation. In particular embodiments, control system 371 will detect the current liquid temperature via temperature sensor 316, and based on the user specified desired temperature, will automatically select either heating or cooling mode.

Referring additionally now to FIG. 10, five frames 371-375 displayed on a control panel 370 to provide inputs to control system 371 are illustrated in one exemplary embodiment. Frames 371-375 can include “Next” and “Back” controls for the user to move between frames as needed. In a first frame 371, a user can select either temperature control mode or a cleaning mode. Second frame 372 then displays controls for actuators 215 and 225 to raise and lower inlet conduit 210 and exit conduit 220 with respect to container 150 and liquid 130. Dependent upon which mode was selected in frame 371, specific instructions can be provided with respect to the controls. If temperature control mode was selected in frame 371, then frame 373 will display controls for the user to enter a desired temperature for liquid 130. The temperature setpoint can be displayed in both Celsius and Fahrenheit, and recommended temperatures for different liquids can be provided for reference by the user. Frame 374 can display the current temperature of liquid 130 (e.g., via temperature sensor 316) as well as the elapsed time of operation of apparatus 300. Frame 374 can also display any warnings based on user inputs and/or sensor values (e.g., if inlet conduit 210 or exit conduit 220 is improperly positioned, or if any of the fluid temperature readings are outside of a desired range). Accordingly, control panel 370 provides a graphical user interface that provides effective and efficient control of apparatus 300 to heat or cool liquid 130 as desired.

It is understood that the embodiments shown and described herein are merely exemplary and that other embodiments within the scope of this disclosure may include a different combination of components or fewer components. For example, in certain embodiments of the present disclosure that do not require cooling functionality, container 161 and solenoid valves 301-304 can be eliminated to reduce initial cost.

### Test Results and Data

Tests were performed to demonstrate the capability of embodiments of the present disclosure (referred to hereinafter as “RealCool”) to warm breast milk compared to traditional methods using a commercially available bottle warmer operating in high power mode and low power mode. In the tests, 240 ml of refrigerated milk to 37° C. was heated with both systems. The time taken to achieve the temperature change was recorded for each method by the K type thermocouple. The water bath temperature for RealCool was set at 50° C. and the change in liquid's temperature with time was measured by thermocouple and had been transmitted to the Raspberry pi. Cell viability was also measured to compare the capability of both technologies to preserve the vital somatic cell population which is important for immunity.

Similarly, to evaluate the performance of RealCool technology in cooling wine, the temperature was reduced from 20 to 7 degrees Celsius using a water bath filled with ice at 0° C. The refrigerator was used in its regular cooling mode. The time required to attain the desired temperature reduction was noted for each method.

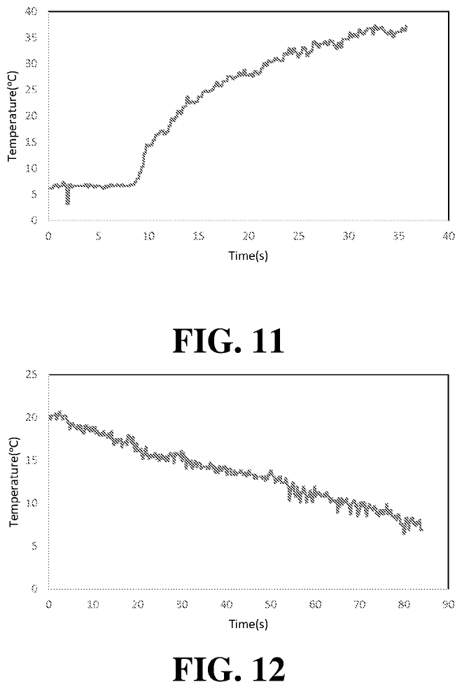

RealCool technology demonstrated remarkable efficiency in warming raw cow milk. The milk achieved a temperature increase from 6 to 37° C. in a mere 36 seconds (as shown in FIG. 11), while the baby bottle warmer took approximately 500 seconds to achieve the same change. This represents a significant fold difference of over 13.9, showcasing a time reduction of over 92% when utilizing RealCool technology compared to the conventional method. Also, for low power mode using the bottle warming, the warming process took more than 30 minutes which is 50 times more than RealCool.

Similarly, RealCool technology displayed exceptional performance in cooling wine. It efficiently decreased the temperature from 20 to 7 degrees Celsius in less than 1.5 minutes (as shown in FIG. 12), whereas the refrigerator took more than 5 hours to achieve the same reduction. This highlights the remarkable speed advantage of RealCool technology, offering a fold difference of approximately 200 and a time saving of about 99.7% compared to traditional refrigeration methods. These results underscore the significant time-saving benefits of RealCool technology in both warming raw cow milk and cooling wine. The rapid temperature change achieved by RealCool technology can enhance operational efficiency and productivity in the respective industries.

### Bacterial Colonization Assay

To showcase the capability for the system to achieve sufficient cleaning/sanitation, To conduct the bacterial colonization assay, raw milk was obtained from Richardson Farms, Texas. The milk was subjected to a heating process using RealCool technology, where a volume of 250 ml was heated from 4° C. to 37° C. to simulate a typical milk warming protocol. Following this, a cleaning protocol was carried out consisting of multiple steps. In step 1 of the cleaning method, a quantity of 500 ml of distilled water at 20° C. was circulated through the system in a single pass. Then the second step involved a subsequent volume of 250 ml of distilled water being repeatedly circulated through the system for 10 seconds (cleaning mode) at either 50° C. or 82° C. to.

The choice of 82° C. as the temperature for the cleaning process is justified by the requirements specified for achieving a minimum 99.999 percent or 5-log reduction of bacteria in commercial dishwashers. According to NSF/ANSI 3 standards, commercial-style dishwashers (excluding stationary rack dishwashers) need to reach a final rinse temperature of 82° C. to meet this condition [64].

Finally, 100 ml of distilled water was circulated through the tubes, and three samples of 0.2 ml each were obtained from it and were added to agar plates for bacterial colonization analysis to assess the effect of water's temperature in sanitization. Also, 0.2 ml of distilled water as the control was added to agar plates. Each agar plate was incubated for 24 hours and then the number of bacterial colonization per agar plate were counted using the following formula:

$$Baterial Colonization = ( Number of Bacterial Colonies / Volume of Samples ) \times Dilution Factor$$

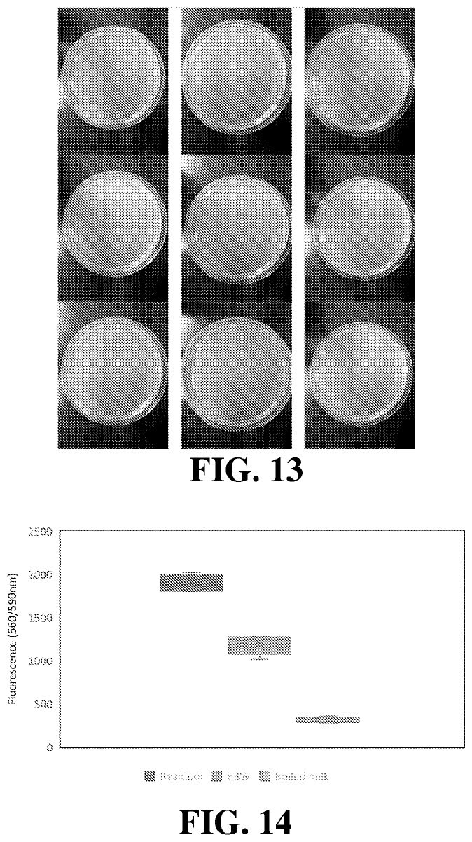

FIG. 13 displays an assessment of the cleaning capability of RealCooL. FIG. 13 displays a comparison of bacterial colonization for agar plate for different conditions a) 0.2 ml of distilled water that was not circulated in RealCool to establish lowest bacterial content resident in distilled water (negative control) and the following cleaning conditions: a quantity of 500 ml of 20° C. distilled water circulated for one pass and then a subsequent volume of 250 ml of distilled water being repeatedly circulated through the system for 10 seconds (cleaning mode) at either b) 82° C. or c) 50° C. All panels in each column are identical (n=3 for each condition).

### Results:

Distilled water was employed as the control, and the absence of bacterial colonization in the distilled water samples is evident from the images. When the distilled water was circulated through the tubes at a temperature of 82° C., the average bacterial count was 431.6 cfu/ml. However, this count increased to 990 cfu/ml when a sanitization method using a temperature of 50° C. was utilized. These findings indicate that the cleaning method utilized for the tubes was effective in minimizing bacterial formation. The observed bacterial counts are relatively low compared to the average bacterial colonization found in milk from healthy women, which typically ranges from 103 to 105 cfu/ml [66]. Therefore, the results suggest that the cleaning method successfully reduced bacterial colonization and achieved a level of bacterial presence that is considered negligible in comparison to the natural occurrence in milk samples from healthy individuals.

### Cell Viability Assay:

To assess the capability of the technology to preserve somatic cell viability through the precise temperature control which prevents overheating characteristic of traditional bottle warmers, the cell viability was measured after the warming process. For the cell viability assay, raw milk was obtained from Richardson Farms, Texas. Three separate samples of the raw milk underwent heating using three different methods: a microwave, a conventional baby bottle warmer, and RealCool. The milk subjected to the microwave treatment was heated to its boiling point and served as the negative control. Aliquots of 50 mL were taken from each sample and underwent additional processing. To remove the fat layer and supernatant, the milk samples were centrifuged at 800×g for 20 minutes. The resulting purified cell pellets were then washed twice with cold phosphate buffered saline solution (PBS) at 400×g for 10 minutes. Afterward, the cell pellets were diluted in 1 mL of PBS.

To conduct the assay, 100 μL of each diluted aliquot was added to individual wells in a 96-well plate, with three repetitions for each sample. Following that, 20 μL of cell titer blue reagent was added to each well, and the plate was incubated for 3 hours to allow for the reaction to take place. Subsequently, the cell viability assay was performed using a plate reader to measure the viability of the cells in each well.

### Results:

In FIG. 14, the graph displays the results of the cell viability experiment using different warming methods for milk. The data reveals distinct patterns in cell viability among the various conditions tested. In particular FIG. 14 displays a cell viability comparison between RealCool, a commercially available baby bottle warmer, and microwave boiling (displayed from upper left to lower right). CellTiter-Blue Reagent (20 μl/well) was added and cells were incubated for 3 hours before recording fluorescence (560(20) Ex/590(10) Em). n=3 for each sample.

Among the warming methods examined, the milk warmed by RealCool demonstrated the highest cell viability compared to the baby bottle warmer and microwave methods. The data clearly indicates a significant difference in cell viability between these two methods. The milk warmed by RealCool had a fluorescence value of 1898.5, indicating strong cell viability. In contrast, the milk warmed by the baby bottle warmer had a lower fluorescence value of 1196.5. Furthermore, the milk boiled with the microwave had the lowest fluorescence value of 307. The cell viability ratio of RealCool to baby bottle warmer can be calculated as 1898.5/1196.5≈1.59, indicating that the cell viability was approximately 59% higher with the RealCool method compared to the baby bottle warmer.

This aligns with prior research conducted by Bransburg-Zabary et al., which demonstrated that baby bottle warmers do not provide even warming and often overheat a substantial amount of refrigerated milk, leading to a significant impact on cell viability [67]. The results from this experiment support this finding, showing that the baby bottle warmer method resulted in lower cell viability compared to the RealCool method.

Overall, the data highlights the effectiveness of the RealCool method in maintaining cell viability during milk warming, while emphasizing the limitations of the baby bottle warmer method. These findings underscore the importance of using precise and controlled warming methods, such as RealCool, to ensure optimal preservation of cell viability and the unique properties of human milk.

All of the devices, systems and/or methods disclosed and claimed herein can be made and executed without undue experimentation in light of the present disclosure. While the devices, systems and methods of this invention have been described in terms of particular embodiments, it will be apparent to those of skill in the art that variations may be applied to the devices, systems and/or methods in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

Computational Algorithm for Simulated Embodiment

%baby bottle warmer 3
clc; clear all; close all;
%geometries
D= .00625; %tube diameter in m (.00625m=.25 in)
P= pi*D; %perimeter in m
Ac= pi*D\hat{ }2/4; %cross section area of tube in m2
L= 1; %Length of tube in m
As= P*L; %surface area (inner or outer assuming thin wall) in m2
w= .0001; %wall thickness of copper pipe in m
V= 2.36E−4; %volume of milk in m3 (240 mL=8 floz)
%material properties
cp= 4181; %specific heat water/milk in J/kgK at T=295K
k= .606; %conductivity water/milk in W/mK at T=293K
rho= 1000; %density of milk in kg/m3
mu=959E−6; %Ns/m2 at T=295K
Pr=6.62; %at T=295K
k_Cu= 401; % thermal conductivity of Copper pipe in W/mK at T=295K
%internal flow of milk
V_dot=6.3E−5; %volumetric flow rate milk via pump in m3/s (1 gal/min)
m_dot= V_dot*rho; %mass flow rate of milk in kg/s (10floz in about 30s) =
.3kg/30s=.01kg/s
Re=4*m_dot/(pi*D*mu) %Reynolds number (dimensionless)
%if Re>2300
Nu=0.023*Re\hat{ }(4/5)*Pr\hat{ }.4 %Nusselt Number (dimensionless)
%If Re<2300 then
%Nu= 3.66; %constant surface temp condition
%Nu= 4.36; %constant surface heat flux condition
h=Nu*k/D %internal heat transfer coefficient in W/m2K
%external flow of water
V_dot_ex=6.3E−5; %volumetric flow rate water via faucet flow in m3/s (1 gal/min)
m_dot_ex= V_dot_ex*rho; %mass flow rate of water in kg/s (10floz in about 30s) =
.3kg/30s=.01kg/s
Ac_res= 0.01*0.01; %cross sectional area of reservior in m2
v= V_dot/Ac_res %velocity of water in reservoir in m/s
Re_ex=rho*v*D/mu %Reynolds number (dimensionless)
%if Re>2300
Nu_ex=0.193*Re_ex\hat{ }(.618)*Pr\hat{ }(0.333) %Nusselt Number (dimensionless)
h_ex=Nu_ex*k/D %external heat transfer coefficient in W/m2K
%overall heat transfer coefficient including internal convection, external
%convection, and conduction in pipe
U= 1/((1/h)+(w/k_Cu)+(1/h_ex)) %overall heat transfer coefficient in W/m2K
%transient temperature of milk analysis
Tinf= 50; %temp of running tap water in C
Ti= 4; %initial input temp of milk in C
Tf= 37; %final desired output temp of milk in C
time=rho*V*cp/(U*As)*log((Ti−Tinf)/(Tf−Tinf)) %time for milk to reach desired temp
t=linspace(0,time*2,1000); %time points along time axis up to 2*time in s
T=(Ti−Tinf)*exp(−(U*As/(rho*V*cp))*t)+Tinf; %Temperature of milk at each time point
%plotting results
plot(t,T)
xlabel(‘time (s)’);
ylabel(‘Temperature (C)’);
hold on
plot(time,Tf,‘r*’)
text(time,Tf,[‘Time=’ num2str(time), ‘s, Temp=’ num2str(Tf), ‘C’])

### REFERENCES

The contents of the following references are incorporated by reference herein:
U.S. Pat. No. 3,402,763
U.S. Pat. No. 5,320,163
U.S. Pat. No. 8,866,050
U.S. Pat. No. 8,951,589
U.S. Pat. No. 10,588,453
U.S. Pat. No. 10,852,057
U.S. Pat. No. 11,363,908
U.S. Pat. No. 11,519,654
US20090078710
US20150267974
FR2788677A1
Loyaa Baby Bottle Warmer 9-in-1, Bottle Warmer for Breast Milk or Formula Fast Milk Warmer with LCD Display Twins Baby Food Heater with Timer Temperature Control
[1] J. Whitney, W. Carswell, N. Rylander, Arrhenius parameter determination as a function of heating method and cellular microenvironment based on spatial cell viability analysis, Int. J. Hyperth. 29 (2013) 281-295.
[2] M. N. Rylander, Y. Feng, K. Zimmermann, K. R. Diller, Measurement and mathematical modeling of thermally induced injury and heat shock protein expression kinetics in normal and cancerous prostate cells, Int. J. Hyperth. 26 (2010) 748-764.
[3] E. Chung, M. N. Rylander, Response of preosteoblasts to thermal stress conditioning and osteoinductive growth factors, Cell Stress Chaperones. 17 (2012) 203-214.
[4] E. Chung, M. N. Rylander, Response of a preosteoblastic cell line to cyclic tensile stress conditioning and growth factors for bone tissue engineering, Tissue Eng. Part A. 18 (2012) 397-410.
[5] E. Chung, A.C. Sampson, M.. Rylander, Influence of heating and cyclic tension on the induction of heat shock proteins and bone-related proteins by MC3T3-E1 cells, Biomed Res. Int. 2014 (2014).
[6] C. G. Victora, R. Bahl, A. J. D. Barros, G. V. A. França, S. Horton, J. Krasevec, S. Murch, M. J. Sankar, N. Walker, N. C. Rollins, Breastfeeding in the 21st century: epidemiology, mechanisms, and lifelong effect, Lancet. 387 (2016) 475-490.
[7] N. C. Rollins, N. Bhandari, N. Hajeebhoy, S. Horton, C. K. Lutter, J. C. Martines, E. G. Piwoz, L. M. Richter, C. G. Victora, Why invest, and what it will take to improve breastfeeding practices?, Lancet. 387 (2016) 491-504.
[8] J. Graffy, J. Taylor, What information, advice, and support do women want with breastfeeding?, Birth. 32 (2005) 179-186.
[9] M. A. Moreno, F. Furtner, F. P. Rivara, Breastfeeding as obesity prevention, Arch. Pediatr. Adolesc. Med. 165 (2011) 772.
[10] C. Binns, M. Lee, W. Y. Low, The long-term public health benefits of breastfeeding, Asia Pacific J. Public Heal. 28 (2016) 7-14.
[11] J. P. Weimer, The economic benefits of breastfeeding: A review and analysis, (1999).
[12] O. of the S. General, Breastfeeding: Surgeon General's Call to Action Fact Sheet, (2011).
[13] A. Walker, Breast milk as the gold standard for protective nutrients, J. Pediatr. 156 (2010) S3-S7.
[14] J. Koh, A. F. Victor, M. L. Howell, J. G. Yeo, Y. Qu, B. Selover, J. Waite-Cusic, D. C. Dallas, Bile Salt-stimulated lipase activity in donor breast milk influenced by pasteurization techniques, Front. Nutr. 7 (2020) 552362.
[15] I. Gonzales, E. J. Duryea, E. Vasquez, N. Geraghty, Effect of enteral feeding temperature on feeding tolerance in preterm infants, Neonatal Netw. NN. 14 (1995) 39-43.
[16] S. Bransburg-Zabary, A. Virozub, F. B. Mimouni, Human milk warming temperatures using a simulation of currently available storage and warming methods, PLoS One. 10 (2015). https://doi.org/10.1371/JOURNAL.PONE.0128806.
[17] A. A. Gelfand, Infant colic, in: Semin. Pediatr. Neurol., Elsevier, 2016: pp. 79-82.
[18] Grownsy, (n.d.). https://grownsyofficial.com.
[19] L. J. C. A. Smarius, T. G. A. Strieder, E. M. Loomans, T. A. H. Doreleijers, T. G. M. Vrijkotte, R. J. Gemke, M. van Eijsden, Excessive infant crying doubles the risk of mood and behavioral problems at age 5: evidence for mediation by maternal characteristics, Eur. Child Adolesc. Psychiatry. 26 (2017) 293-302.
[20] What Parents Need to Know After a Bottle Warmer Burn at Daycare, (n.d.). https://www.buttonlawfirm.com/library/what-to-do-when-your-child-is-burned-by-a-bottle-warmer-at-a-texas-daycare.cfm.
[21] S. Das, D. D. Santani, N. S. Dhalla, Experimental evidence for the cardioprotective effects of red wine, Exp. Clin. Cardiol. 12 (2007) 5.
[22] S. Arranz, G. Chiva-Blanch, P. Valderas-Martínez, A. Medina-Remón, R. M. Lamuela-Raventós, R. Estruch, Wine, beer, alcohol and polyphenols on cardiovascular disease and cancer, Nutrients. 4 (2012) 759-781.
[23] M. M. Markoski, J. Garavaglia, A. Oliveira, J. Olivaes, A. Marcadenti, Molecular properties of red wine compounds and cardiometabolic benefits, Nutr. Metab. Insights. 9 (2016) NMI-S32909.
[24] S. R. Logan, The origin and status of the Arrhenius equation, J. Chem. Educ. 59 (1982) 279.
[25] Kalamera 24 Inch Under Counter Built In Wine Refrigerator 46 Bottle Dual Zone Wine Cooler Fridge, (n.d.). https://kalamera.com/duo-zone-wine-cooler.
[26] WINE COOLER POWER CONSUMPTION CALCULATOR, (n.d.). https://letsavelectricity.com/wine-cooler-power-consumption-calculator/.
[27] Baby Bottle Warmer And Sterilizer Market Size, Share & Trends Analysis Report By Product (Baby Bottle Warmers, Baby Bottle Sterilizers), By Distribution Channel, By Region, And Segment Forecasts, 2021-2028, n.d.
[28] Wine Cooler Market Size, Share & Trends Analysis Report By Product (Free-standing, Countertop, Built-in), By Application (Residential, Commercial), By Region, And Segment Forecasts, 2019-2025, Grand View Research, n.d.
[29] M. Indumathy, S. Sobana, B. Panda, R. C. Panda, Modelling and control of plate heat exchanger with continuous high-temperature short time milk pasteurization process—A review, Chem. Eng. J. Adv. (2022) 100305.
[30] C. Perry, L. Pelchen, Tankless Water Heater vs. Tank Storage Water Heater, (n.d.). https://www.forbes.com/home-improvement/plumbing/tankless-water-heater-vs-tank/.
[31] Tankless or Demand-Type Water Heaters, (n.d.). https://www.energy.gov/energysaver/tankless-or-demand-type-water-heaters.
[32] M. J. Moran, H. N. Shapiro, D. D. Boettner, M. B. Bailey, Fundamentals of engineering thermodynamics, John Wiley & Sons, 2010.
[33] T. L. Bergman, A. S. Lavine, F. P. Incropera, D. P. DeWitt, Introduction to heat transfer, John Wiley & Sons, 2011.
[34] Dishwasher Certification, (n.d.). https://www.nsf.org/consumer-resources/articles/dishwasher-certification.
[35] H. R. Thornton, E. G. Hastings, STUDIES ON OXIDATION-REDUCTION IN MILK II. THE CHOICE OF AN INDICATOR FOR THE REDUCTION TEST. THE REDUCTION OF JANUS GREEN B IN MILK, J. Bacteriol. 18 (1929) 319-332.
[36] M. Anderson, P. Hinds, S. Hurditt, P. Miller, D. McGrowder, R. Alexander-Lindo, The microbial content of unexpired pasteurized milk from selected supermarkets in a developing country, Asian Pac. J. Trop. Biomed. 1 (2011) 205-211.
[37] P. Hoddinott, D. Tappin, C. Wright, Breast feeding, Bmj. 336 (2008) 881-887.
[38] L. M. Bergquist, B. Pogosian, Microbiology: Principles and health science applications, Saunders, 2000.
[39] M. Purschke, H.-J. Laubach, R. R. Anderson, D. Manstein, Thermal injury causes DNA damage and lethality in unheated surrounding cells: active thermal bystander effect, J. Invest. Dermatol. 130 (2010) 86-92.
[40] G. Boisclair, Evaluation de la santé de la vache après le vêlage, Med. Vet. 1 (2007) 45-47.
[41] L. B. Larsen, H. Wium, C. Benfeldt, C. W. Heegaard, Y. Ardö, K. B. Qvist, T. E. Petersen, Bovine milk procathepsin D: presence and activity in heated milk and in extracts of rennet-free UF-Feta cheese, Int. Dairy J. 10 (2000) 67-73.
[42] J. C. Cappozzo, T. Koutchma, G. Barnes, Chemical characterization of milk after treatment with thermal (HTST and UHT) and nonthermal (turbulent flow ultraviolet) processing technologies, J. Dairy Sci. 98 (2015) 5068-5079.
[43] M. Van Boekel, Effect of heating on Maillard reactions in milk, Food Chem. 62 (1998) 403-414.
[44] R. Pizzano, C. Manzo, M. Adalgisa Nicolai, F. Addeo, Occurrence of major whey proteins in the pH 4.6 insoluble protein fraction from UHT-treated milk, J. Agric. Food Chem. 60 (2012) 8044-8050.
[45] J. N. De Wit, Thermal stability and functionality of whey proteins, J. Dairy Sci. 73 (1990) 3602-3612.
[46] G. W. Krissansen, Emerging health properties of whey proteins and their clinical implications, J. Am. Coll. Nutr. 26 (2007) 713S-723S.
[47] M. Akkerman, V. M. Rauh, M. Christensen, L.B. Johansen, M. Hammershøj, L.B. Larsen, Effect of heating strategies on whey protein denaturation—Revisited by liquid chromatography quadrupole time-of-flight mass spectrometry, J. Dairy Sci. 99 (2016) 152-166.
[48] R. Adjonu, G. Doran, P. Torley, S. Agboola, Screening of whey protein isolate hydrolysates for their dual functionality: Influence of heat pre-treatment and enzyme specificity, Food Chem. 136 (2013) 1435-1443.
[49] I. B. O'Loughlin, B. A. Murray, R. J. Fitzgerald, A. Brodkorb, P. M. Kelly, Pilot-scale production of hydrolysates with altered bio-functionalities based on thermally-denatured whey protein isolate, Int. Dairy J. 34 (2014) 146-152.
[50] L. C. Laleye, B. Jobe, A. A. H. Wasesa, Comparative study on heat stability and functionality of camel and bovine milk whey proteins, J. Dairy Sci. 91 (2008) 4527-4534.
[51] S. Laiho, D. Ercili-Cura, P. Forssell, P. Myllärinen, R. Partanen, The effect of dynamic heat treatments of native whey protein concentrate on its dispersion characteristics, Int. Dairy J. (2015) 139-147.
[52] Y. Zhang, L. Min, S. Zhang, N. Zheng, D. Li, Z. Sun, J. Wang, Proteomics Analysis Reveals Altered Nutrients in the Whey Proteins of Dairy Cow Milk with Different Thermal Treatments, Molecules. 26 (2021) 4628.
[53] B. Kuehn, Breastfeeding report card, Jama. 320 (2018) 1426.
[54] R. Michna, M. Gadde, A. Ozkan, M. DeWitt, M. Rylander, Vascularized microfluidic platforms to mimic the tumor microenvironment, Biotechnol. Bioeng. 115 (2018) 2793-2806. https://doi.org/10.1002/BIT.26778.
[55] J. Widmer, L. Descloux, C. Brügger, M.-L. Jäger, T. Berger, L. Egger, Direct labeling of milk cells without centrifugation for counting total and differential somatic cells using flow cytometry, J. Dairy Sci. 105 (2022) 8705-8717.
[56] ISO13366-2/IDF148-2, Milk-Enumeration of somatic cells—Part 2: guidance on the operation of fluoro-opto-electronic counters. International Dairy Federation Standard, 2006.
[57] N. Li, R. Richoux, M.-H. Perruchot, M. Boutinaud, J.-F. Mayol, V. Gagnaire, Flow cytometry approach to quantify the viability of milk somatic cell counts after various physico-chemical treatments, PLoS One. 10 (2015) e0146071.
[58] P. Freire, A. Zambrano, A. Zamora, M. Castillo, Thermal Denaturation of Milk Whey Proteins: A Comprehensive Review on Rapid Quantification Methods Being Studied, Developed and Implemented, Dairy. 3 (2022) 500-512.
[59] F. Qian, J. Sun, D. Cao, Y. Tuo, S. Jiang, G. Mu, Experimental and modelling study of the denaturation of milk protein by heat treatment, Korean J. Food Sci. Anim. Resour. 37 (2017) 44.
[60] J. A. Lucey, M. TAMEHANA, H. Singh, P. A. MUNRO, Effect of interactions between denatured whey proteins and casein micelles on the formation and rheological properties of acid skim milk gels, J. Dairy Res. 65 (1998) 555-567.
[61] A. F. Recamales, V. Gallo, D. Hernanz, M. L. GONZÁLEZ-MIRET, F. J. Heredia, Effect of time and storage conditions on major volatile compounds of Zalema white wine, J. Food Qual. 34 (2011) 100-110.
[62] P. Ribéreau-Gayon, D. Dubourdieu, B. Donèche, A. Lonvaud, Handbook of enology, Volume 1: The microbiology of wine and vinifications, John Wiley & Sons, 2006.
[63] M. J. Cejudo-Bastante, I. Hermosín-Gutiérrez, M. S. Pérez-Coello, Accelerated aging against conventional storage: Effects on the volatile composition of chardonnay white wines, J. Food Sci. 78 (2013) C507-C513.
[64] Dishwasher Certification, (n.d.). https://www.nsf.org/consumer-resources/articles/dishwasher-certification.
[65] P. Feng, S. D. Weagant, M. A. Grant, W. Burkhardt, M. Shellfish, B. Water, BAM: Enumeration of Escherichia coli and the Coliform Bacteria, Bacteriol. Anal. Man. 13 (2002) 1-13.
[66] S.-W. Li, K. Watanabe, C.-C. Hsu, S.-H. Chao, Z.-H. Yang, Y.-J. Lin, C.-C. Chen, Y.-M. Cao, H.-C. Huang, C.-H. Chang, Bacterial composition and diversity in breast milk samples from mothers living in Taiwan and Mainland China, Front. Microbiol. 8 (2017) 965.
[67] S. Bransburg-Zabary, A. Virozub, F. B. Mimouni, Human milk warming temperatures using a simulation of currently available storage and warming methods, PLoS One. 10 (2015). https://doi.org/10.1371/JOURNAL.PONE.0128806.

1. An apparatus for cooling or heating a liquid in a container, the apparatus comprising:
a first conduit;
a second conduit;
a pump in fluid communication with the first conduit and the second conduit; and
a thermal energy transfer mechanism, wherein:
the pump is configured to transfer the liquid from the container to the thermal energy transfer mechanism via the first conduit;
the thermal energy transfer mechanism is configured to cool or heat the liquid; and
the pump is configured to transfer the liquid from the thermal energy transfer mechanism to the container via the second conduit.

2. The apparatus of claim 1 wherein the thermal energy transfer mechanism comprises:
a heat exchanger in fluid communication with the first conduit and the second conduit; and
a reservoir.

3. (canceled)

4. (canceled)

5. The apparatus of claim 2 wherein:
the pump in fluid communication with the first conduit and the second conduit is a first pump;
the apparatus further comprises a second pump; and
the second pump is configured to circulate a thermal energy transfer fluid through the heat exchanger.

6. The apparatus of claim 5 further comprising a heater in fluid communication with the second pump and the heat exchanger.

7. The apparatus of claim 6 wherein:
the thermal energy transfer fluid is contained in the reservoir; and
the thermal energy transfer fluid is colder than the liquid in the container.

8. The apparatus of claim 6 wherein the heater is configured to heat the thermal energy transfer fluid to a temperature that is hotter than the liquid in the container.

9. The apparatus of claim 6 further comprising a plurality of control valves configured to:
control a first flow of the thermal energy transfer fluid from the reservoir, through the second pump and heat exchanger and back to the reservoir; and
control a second flow of the thermal energy transfer fluid from the pump, through the heater and heat exchanger and back to the second pump.

10. The apparatus of claim 1 further comprising:
a first actuator configured to insert and retract the first conduit into the container; and
a second actuator configured to insert and retract the second conduit into the container.

11. The apparatus of claim 2 wherein the reservoir comprises an inlet and an outlet.

12. The apparatus of claim 11 wherein:
the inlet is in fluid communication with a fluid source; and
the fluid source comprises at least one of a hot fluid source or a cold fluid source.

13. (canceled)

14. (canceled)

15. The apparatus of claim 12 further comprising at least one of:
a temperature sensor configured to monitor the temperature of the fluid in the first conduit or the temperature of the fluid in the container; and
a control valve configured to control a flow of fluid from the fluid source.

16. (canceled)

17. (canceled)

18. The apparatus of claim 2 further comprising one or more heat transfer elements in a fluid in the reservoir.

19. The apparatus of claim 18 wherein the one or more heat transfer elements comprise ice.

20. The apparatus of claim 18 wherein the one or more heat transfer elements comprise a heating element.

21. The apparatus of claim 18 further comprising a stirring mechanism.

22. The apparatus of claim 21 wherein the stirring mechanism is configured to stir the heat transfer elements and the fluid within the reservoir.

23. The apparatus of claim 1 further comprising at least one of:
a first temperature sensor configure to monitor the temperature of the fluid in the second conduit; and
a second temperature sensor configured to monitor the temperature of the fluid in the reservoir.

24. (canceled)

25. (canceled)

26. The apparatus of claim 1 further comprising a container comprising a cleaning fluid.

27. The apparatus of claim 26 wherein the apparatus is configured to circulate the cleaning fluid through the first conduit, the second conduit, the pump and the thermal energy transfer mechanism.

28. The apparatus of claim 1 further comprising a controller configured to control operation of the apparatus, wherein the controller comprises an on/off selector, a temperature set point controller, a temperature set point display and a clean cycle selector.

29.-31. (canceled)
